(19) United States
(12) Patent Application Publication
(10) Pub. No.: US 2008/0190730 A1
(43) Pub. Date: Aug. 14, 2008

(54) CURRENCY NOTE AND TICKET PROCESSING APPARATUS

(75) Inventors: Peter Ronald SMITH, Essendon (AU); Robert Kingsley Bird, Burwood (AU)

Correspondence Address: MERCHANT & GOULD PC, P.O. BOX 2903, MINNEAPOLIS, MN, 55402-0903, US

(73) Assignee: Microsystem Controls Pty Ltd, South Melbourne (AU)

(21) Appl. No.: 12/021,509

(22) Filed: Jan. 29, 2008

(30) Foreign Application Priority Data
Jan. 29, 2007 (AU) 2007900408

(51) Int. Cl. G07F 7/04

(52) U.S. Cl. 194/206

(57) ABSTRACT

Currency note and ticket processing apparatus, includes a housing, and a currency note validator for examining and validating or rejecting currency notes. A redeemable ticket reader is provided for reading redeemable tickets, while a printer is included to prepare new redeemable tickets for issuance for later redemption. Further provided is structure defining one or more pathways within the housing and an opening in an external wall of the housing communicable with the pathway(s) whereby the opening is a common opening at which currency notes or redeemable tickets are inserted into the housing and conveyed respectively to and beyond the currency note validator and the redeemable ticket reader, and at which new redeemable tickets prepared by the printer are issued from the housing. Means is provided for driving currency notes or redeemable tickets along the pathway(s) to or from the common opening.

### FIELD OF THE INVENTION

This invention relates generally to mechanisms for processing currency notes and redeemable tickets, and has particular, though not exclusive, application as an accessory where both currency and redeemable tickets may be employed for purchasing purposes. Gaming machines are a typical example. By “redeemable ticket” is meant a ticket, coupon or the like that carries an identification code by which it may be accorded a redeemable value (which may change over time), or a code directly identifying its face value. The code is machine readable and may be in any convenient form, for example a barcode, a magnetic stripe, RFID code or otherwise.

### BACKGROUND OF THE INVENTION

Traditional gaming machines are activated by the presentation of coins or currency notes, or both, and thus have long been fitted with coin and/or currency note entry slots each having an associated validator within the machine. It is now common practice for gaming machines to be linked into local area networks, which allows customers to access and play on the machines by using bar-coded redeemable tickets purchased at a cashier console or issued as credit in lieu of cash. The barcode carries a characteristic identifier for the ticket, by which the network computer can determine and assign the appropriate credit to the relevant gaming machine.

It has been proposed in U.S. Pat. Nos. 6,048,269 and 6,852,029 that currency note validators mounted in gaming machines be modified to also incorporate a barcode reader for scanning redeemable tickets so that customers may obtain access to the gaming machines by presenting either currency notes or redeemable tickets.

It is also known from the aforementioned US patents for a gaming machine to be fitted with a separate ticket printer, typically a commercially available printer, mounted for the purpose in its own location on the front of the machine. This facility allows the customer to opt to receive winnings in the form of a credit via a coded redeemable ticket which can be presented subsequently to the ticket reader on the same machine or another machine. In conventional ticket printer arrangements (U.S. Pat. No. 6,648,761 is one disclosure) there is often a quite complex pathway arising from the need to pass the ticket along a validation path from which it can either be directed to a storage stack or reversed out as a valid ticket. U.S. Pat. No. 6,852,029 briefly suggests that the functionality of the ticket reader and ticket printer may be incorporated into a single device, and that the ticket printer may be incorporated into the bill validator. Although these ideas are conceptually proposed, there is no disclosure as to how they might be practically implemented. The present invention is directed to that objective.

### SUMMARY OF THE INVENTION

The invention provides, in a first aspect, currency note and ticket processing apparatus, including:
a housing;
currency note validation means for examining and validating or rejecting currency notes;
redeemable ticket reader means for reading redeemable tickets;
ticket preparing means for preparing new redeemable tickets for issuance for later redemption; and
structure defining one or more pathways within said housing and an opening in an external wall of the housing communicable with said pathway(s) whereby said opening is a common opening at which currency notes or redeemable tickets are inserted into the housing and conveyed respectively to and beyond said currency note validation means and said redeemable ticket reader means, and at which new redeemable tickets prepared by said ticket preparing means are issued from the housing, means being provided for driving currency notes or redeemable tickets along said pathway(s) to or from said common opening.

In a second aspect, the invention provides currency note and ticket processing apparatus, including:
a housing;
structure to mount currency note validation means and redeemable ticket reader means for examining and validating currency notes and reading redeemable tickets respectively;
ticket preparing means for preparing new redeemable tickets for issuance for later redemption; and
structure defining one or more pathways within said housing and an opening in an external wall of the housing communicable with said pathway(s) whereby said opening is a common opening at which currency notes or redeemable tickets are inserted into the housing and conveyed respectively to and beyond said currency note validation means and said redeemable ticket reader means, and at which new redeemable tickets prepared by said ticket preparing means are issued from the housing, means being provided for driving currency notes or redeemable tickets along said pathway(s) to or from said common opening.

Preferably, the redeemable ticket reader means is co-operatively associated with the pathway(s) so that it is actuable to read a ticket delivered into the pathway(s) by said ticket preparing means as it traverses the pathway(s) to the common opening.

In one convenient arrangement, the redeemable ticket reader means would be a barcode reader for reading a characteristic identifier barcode carried by each redeemable ticket.

Conveniently, the redeemable ticket reader means is in the same region of said one or more pathway(s) as the currency note validation means.

The one or more pathway(s) may include a main pathway segment and a branch path for delivering new redeemable tickets into the main pathway segment for conveyance to the common opening, and along which branch path the ticket preparing means is located. The branch path is preferably upstream of the redeemable ticket reader means relative to the direction of travel of the new redeemable tickets. Preferably, there is a gate operable to allow the new redeemable tickets into the main pathway segment while preventing currency notes and redeemable tickets inserted into the common opening from diverting into said branch path.

The apparatus may further include ticket issuing means for issuing new tickets and a printer actuable to apply a unique identifier code to each issued ticket whereby it becomes a new redeemable ticket.

The ticket issuing means preferably includes a replaceable cartridge for blank printable tickets.

Conveniently, the ticket issuing means is a discrete modular unit that is selectively and detachably mountable to said housing with a ticket issuing port on the unit in register with an opening to said branch path, whereby new tickets may be issued into said branch path for delivery to the common opening.

In one arrangement, the pathway, the note validation means and the redeemable ticket reader means are disposed in said housing, with said common opening in a side wall of the housing, and the ticket issuing means is provided in a sub-housing coupled to said housing.

Preferably, the one or more pathways have has one or more end openings remote from the common opening, from which end openings validated and accepted currency notes and tickets are delivered or able to be delivered to a storage module. Separate such end-openings may be provided for the currency notes and tickets respectively, each at an end of a respective pathway. The storage module is conveniently one or more discrete modular units selectively and detachably mountable to said housing.

The apparatus will normally include a controller for activation of the means for driving currency note and redeemable tickets and of said gate responsive to the currency note validation means and the redeemable ticket reader means.

The controller may be programmed whereby any item inserted into said common opening and not either validated at the currency note validation means or identified at the redeemable ticket reader means as a valid redeemable ticket with outstanding credit is reversed along the one or more pathway(s) back out through the common opening.

In specific embodiments, validated tickets might be returned back out through the common opening.

The redeemable ticket reader means may be additionally configured to validate the new redeemable tickets. The controller may be configured whereby any redeemable tickets not validated may be directed to the relevant storage module.

### BRIEF DESCRIPTION OF THE DRAWINGS

The invention will now be further described, by way of example only, with reference to the accompanying drawings, in which:

FIG. 1 is a schematic vertical sectional view of a configuration of currency note and ticket processing apparatus according to an embodiment of the invention depicted in a note receiving condition; and

FIG. 2 is a similar view of the apparatus shown in a ticket receiving condition with some parts omitted.;

### EMBODIMENTS OF THE INVENTION

The illustrated currency note and ticket processing apparatus 10 consists of three principal components, a main housing 20 and respective modular clip-on units 30, 40. Housing 20 in turn has an intermediate section formed as a cradle 22 for removably receiving and snugly mounting a combination currency note validator and ticket reader 50.

Currency note validator and ticket reader 50 will typically be a currency note validator of known configuration and may be an existing commercially available unit with an added-on ticket reading facility. As such, it would normally have a currency note path 55 extending through the reader from an entrance 56 in a front wall 57 of the reader to an exit 58 in a rear wall 59. Currency note path 55 has an associated drive mechanism such as a belt or rollers 65 operable to drive a currency note, or ticket, in either direction between the respective openings 56, 58. (Only one roller pair of drive mechanism 65 is actually shown). Along the path, and in operative association with the path, is a currency note validator and a ticket reading device, typically in the form of a barcode reader indicated in the drawing at 60.

It will be understood that the currency note validator may typically include an array 53 of optical elements adapted to scan and respond to predetermined elements of a currency note traversing path 55 whereby to obtain and record a signature signal for the note, and a controller 51 for responding to the comparison (and to the barcode reader 60) that includes a discriminator facility for comparing each recorded signature signal with reference signatures or with predetermined value ranges for components of the signature.

Housing 20 further includes structure defining spaced further segments 25a, 25b, 25c, 25d, 28 of multiple note pathways 25 for currency notes and redeemable tickets that includes path 55. Pathways 25 are of generally rectangular cross-section, and of relatively large width and small height, and the aforementioned segments include a first main pathway segment that is an entrance segment 25a for guiding a note or ticket from an opening 26 in an external front wall 21 of housing 20 to entrance 56 of validator/reader note path 55. A further main pathway segment 25b of pathways 25 trails from a rear wall of cradle 22 that engages wall 59 of reader 50 so that pathway segment 25b is in register with exit 58 of validator/reader note path 55. The part of wall 21 below pathway segment 25a is spaced from the front wall of cradle 22 to define a space 27 by which housing 20 may be secured in place behind a front wall of a gaming or other machine to which the apparatus is mounted.

It will be appreciated from the following description that opening 26 is a common or single opening through which currency notes or redeemable tickets are inserted into the housing, through which new redeemable tickets are issued from the housing, and through which items not validated are returned.

Pathway segment 25a and validator/reader note path 55 are shaped to provide respective off-sets as shown for restricting access by non-authorised objects.

Mounted behind the rear end of pathway segment 25b is a gate mechanism 75 consisting of a pair of hinged flaps 75a, 75b that can be cooperatively positioned by an actuator 76 in three different configurations to communicate pathway segment 25b with a selected one of further pathway segments 25c, 25d and a branch path 28, which lead in turn to respective exit openings or ports 80, 81, and 82 in a base wall 29 of housing 20. Each pathway segment 25b, 25c, 25d, 28 includes a conveyance mechanism represented by roller pair 65^{l} for driving a note or ticket along the pathway, in the case of branch path 28 in either direction.

Gate actuator 76 may include a stepper motor that drives a gear with a cranked link to the gate, as illustrated.

Housing 20 further carries suitable clip mountings (not shown) for releasably fitting, under base wall 29, stacker module 30 and ticket issuing module 40. The stacker module 30 is shown only schematically but might typically include a note stacker compartment 32 and a ticket stacker compartment 34 having respective entrance ports 33, 35 that respectively register with exit openings 80 and 81 of housing 20 and each have a pair of rollers defining a drive nip at the respective port. The compartments 32, 34 have scissor-coupled push plate mechanisms 37, 39 and a single rack actuator 38 that can selectively operate either mechanism to drive the newest arriving note or ticket into its stack.

Ticket issuing module 40 has a replaceable cartridge of blank tickets 41 and a driver (represented by roller 42) actuable to issue tickets singly from the cartridge through an exit port 43, which is in register with branch path port 82 when it is correctly fitted to housing 20. Branch path 28 includes ticket preparing means in the form of a printer 45 actuable to apply a unique code, e.g. a barcode to each issued ticket as it is conveyed along the branch path from opening 82.

The various operational modes of the illustrated apparatus will now be described, with reference to the case where it is installed in a gaming machine. A client proposing to use the gaming machine may present either a currency note or a redeemable ticket through common opening 26. The redeemable ticket would typically contain an optically readable characteristic identifier code, e.g. in the form of a barcode, for uniquely identifying the ticket and assigning a value to it, either permanently or temporarily. The value is in turn recorded in a network computer essentially managing an array of multiple note and ticket readers and ticket printers.

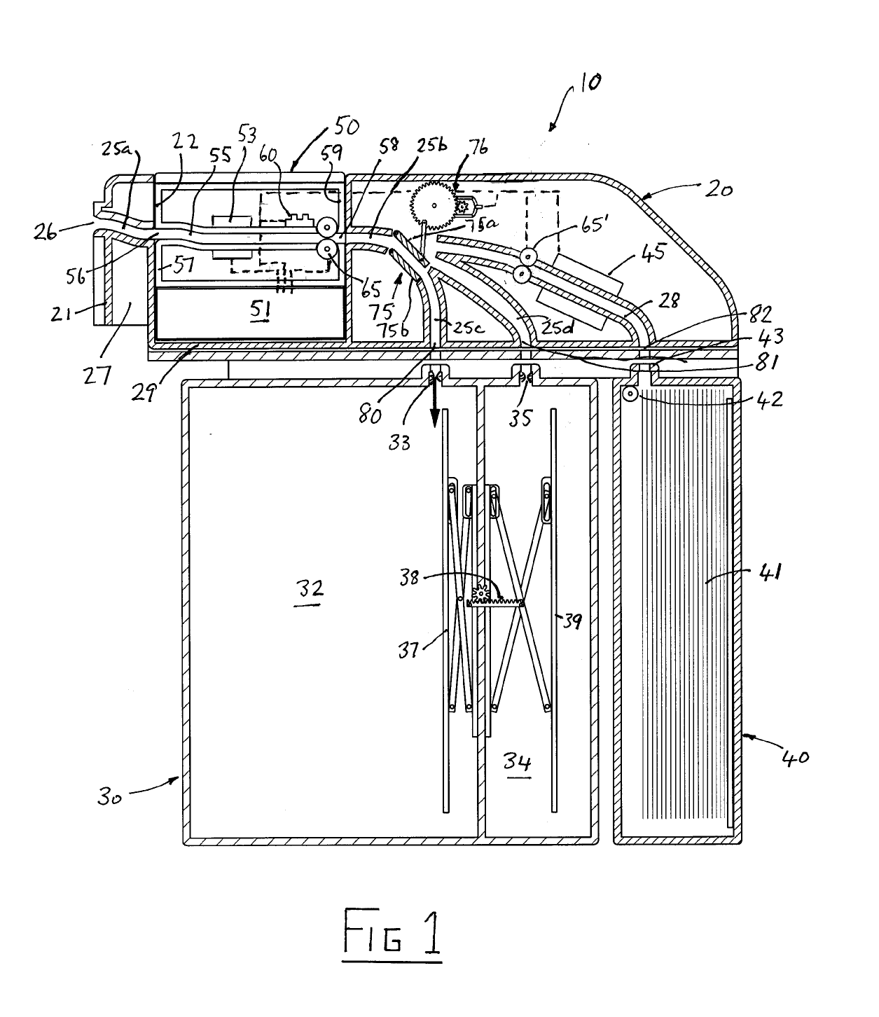

If the currency note validator of reader 24 recognises the inserted item as a valid denomination currency note, its controller 51 will issue an enabling credit signal to associated equipment, and cause actuator 76 to set gate 75 for pathway segment 25c. This is the setting of gate 75 in FIG. 1. The drive mechanism 65,65^{l} is then activated to move the note along this pathway segment to note stacker compartment 32, where push or stacker mechanism 37 is set to receive the note. Controller 51 sets gate 75, the roller nip at port 33, and push or stacker mechanism 37 for synchronous operation.

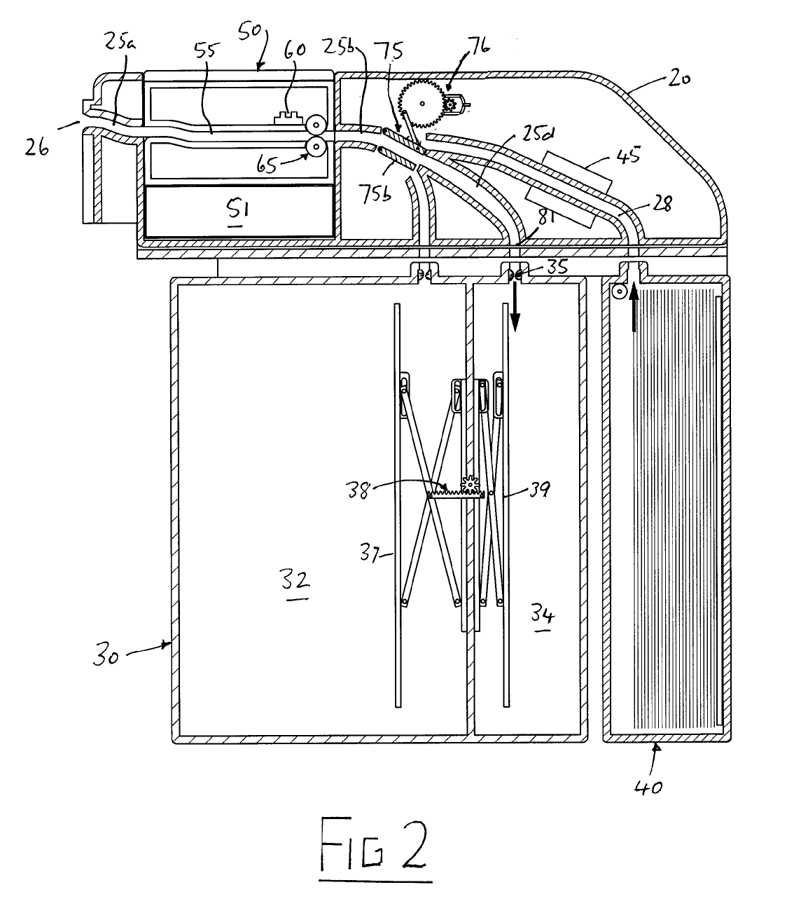

Alternatively, if the reader 60 recognises a valid redeemable ticket having an appropriate face value, a credit signal will be issued and gate 75 will be set for pathway segment 25d (FIG. 2) and the ticket driven to ticket stacker compartment 34. Here, push mechanism 39 is now set (synchronously with gate 75 and the drive roller nip at port 35) to receive the ticket. If the inserted item is not recognised or validated as either an acceptable denomination currency note or a redeemable ticket with an appropriate face value, controller will reverse the drive mechanism 65 and return the item out through common opening 26.

If the provider of a validated item now operates the gaming machine and in due course is successful in maintaining or augmenting the initial credit position, he or she may opt to receive the credit by way of a redeemable ticket. Appropriate actuation of a keypad or other interface causes ticket issuing module 40 to issue a ticket to branch path 28, where printer 45 applies a characteristic barcode to thereby prepare a new redeemable ticket that passes along branch path 28 into reader pathway 55. To enable this operation, gate 75 will have been set by actuator 76 to allow the ticket to pass from branch path 28 into pathway segment 25b from where it is conveyed out through common opening 26 by the drive mechanism 65.

In a modification, which would require some re-configuration of the illustrated layout, barcode reader 60 might examine the ticket as it reaches the reader. Only if reader 60 validates the ticket to the controller as correctly printed is it driven out through common opening 26. If the new ticket failed the validation test the drive mechanism 65 would be reversed, gate 75 set appropriately and the rejected ticket directed to ticket stacker compartment 34. This operation would trigger issuance of a new ticket to reader 45 from module 40. A significant advantage of the inventive apparatus is that combination reader 50 can be used for this purpose of validating a newly issued ticket. In conventional ticket printer arrangements, there is often a quite complex pathway arising from the need to pass the ticket along a validation path from which it can either be directed to a storage stack or reversed out as a valid ticket. Construction of the ticket printer can thus be much simplified.

In a variation, validated tickets received through common opening 26 might be returned to the client rather than directed to the stacker, for use, for example, as a receipt or to provide printed credit information. In another variation, unvalidated or rejected tickets inserted at common opening 26 might be directed to the stack rather than returned through opening 26.

It will be appreciated that the particular arrangement of the illustrated embodiment allows complete flexibility of application and operation. By appropriate pre-setting of the controller 51 associated with the reader or the main machine, the reader may be set only to recognise currency notes and to be unable to process tickets, either incoming or outgoing. In another setting, it may be configured to receive either currency notes or redeemable tickets but not to issue new tickets, in which case module 40 would not be required. Furthermore, while the drawing illustrates a combination note stacker and ticket stacker module, these may be separate modules and indeed a stacker module may be provided that receives both tickets and currency notes through a single entrance port.

1. Currency note and ticket processing apparatus, including:
a housing;
currency note validation means for examining and validating or rejecting currency notes;
redeemable ticket reader means for reading redeemable tickets;
ticket preparing means for preparing new redeemable tickets for issuance for later redemption; and
structure defining one or more pathways within said housing and an opening in an external wall of the housing communicable with said pathway(s) whereby said opening is a common opening at which currency notes or redeemable tickets are inserted into the housing and conveyed respectively to and beyond said currency note validation means and said redeemable ticket reader means, and at which new redeemable tickets prepared by said ticket preparing means are issued from the housing, means being provided for driving currency notes or redeemable tickets along said pathway(s) to or from said common opening.

2. Apparatus according to claim 1 wherein the redeemable ticket reader means is co-operatively associated with said pathway(s) so that it is actuable to read a ticket delivered into the pathway(s) by said ticket preparing means as it traverses the pathway(s) to the common opening.

3. Apparatus according to claim 2 wherein the redeemable ticket reader means is a barcode reader for reading a characteristic identifier barcode carried by each redeemable ticket.

4. Apparatus according to claim 2 wherein the redeemable ticket reader means is in the same region of said one or more pathways as the currency note validation means.

5. Apparatus according to claim 1 wherein said one or more pathway(s) include a main pathway segment and a branch path for delivering new redeemable tickets into said main pathway segment for conveyance to the common opening and along which branch path said ticket preparing means is located.

6. Apparatus according to claim 5 wherein said branch path is upstream of the redeemable ticket reader means relative to the direction of travel of said new redeemable tickets.

7. Apparatus according to claim 5 further including a gate operable to allow the new redeemable tickets into said main pathway segment while preventing currency notes and redeemable tickets inserted into said opening from diverting into said branch path.

8. Apparatus according to claim 5, further including ticket issuing means for issuing new tickets and a printer actuable to apply a unique identifier code to each issued ticket whereby it becomes a new redeemable ticket.

9. Apparatus according to claim 8 wherein the ticket issuing means includes a replaceable cartridge for blank printable tickets.

10. Apparatus according to claim 8 wherein the ticket issuing means is a discrete modular unit that is selectively and detachably mountable to said housing with a ticket issuing port on the unit in register with an opening to said branch path, whereby new tickets may be issued into said branch path for delivery to said common opening.

11. Apparatus according to claim 1 wherein said one or more pathways have one or more end openings remote from the common opening, from which end openings validated and accepted currency notes and tickets are delivered, or are able to be delivered, to a storage module.

12. Apparatus according to claim 11 wherein separate said end-openings are provided for the currency notes and tickets respectively, each at an end of a respective pathway.

13. Apparatus according to claim 11 wherein said storage module is one or more discrete modular units selectively and detachably mountable to said housing.

14. Apparatus according to claim 1 including a controller for activation of said means for driving currency note and redeemable tickets and of said gate, responsive to said currency note validation means and said redeemable ticket reader means.

15. Apparatus according to claim 14 wherein said controller is programmed whereby any item inserted into said common opening and not either validated at the currency note validation means or identified at the redeemable ticket reader means as a valid redeemable ticket with outstanding credit is reversed along said one or more pathways back out through the common opening.

16. Apparatus according to claim 14 wherein the redeemable ticket reader means is additionally configured to validate said new redeemable tickets, and said apparatus is configured whereby new redeemable tickets not validated are directed to the relevant said storage module.

17. Currency note and ticket processing apparatus, including:
a housing;
structure to mount currency note validation means and redeemable ticket reader means for examining and validating currency notes and reading redeemable tickets respectively;
ticket preparing means for preparing new redeemable tickets for issuance for later redemption; and
structure defining one or more pathways within said housing and an opening in an external wall of the housing communicable with said pathway(s) whereby said opening is a common opening at which currency notes or redeemable tickets are inserted into the housing and conveyed respectively to and beyond said currency note validation means and said redeemable ticket reader means, and at which new redeemable tickets prepared by said ticket preparing means are issued from the housing, means being provided for driving currency notes or redeemable tickets along said pathway(s) to or from said common opening.

18. Apparatus according to claim 17 wherein the redeemable ticket reader means is co-operatively associated with said pathway(s) so that it is actuable to read a ticket delivered into the pathway(s) by said ticket preparing means as it traverses the pathway(s) to the opening.

19. Apparatus according to claim 18 wherein the redeemable ticket reader means is a barcode reader for reading a characteristic identifier barcode carried by each redeemable ticket.

20. Apparatus according to claim 18 wherein said one or more pathway(s) include a main pathway segment and a branch path for delivering new redeemable tickets into said main pathway segment and along which said ticket preparing means is located.

21. Apparatus according to claim 20 wherein said branch path is upstream of the redeemable ticket reader means relative to the direction of travel of said new redeemable tickets.

22. Apparatus according to claim 20 further including a gate operable to allow the new redeemable tickets into said main pathway segment while preventing currency notes and redeemable tickets inserted into said opening from diverting into said branch path.

23. Apparatus according to claim 20, further including ticket issuing means for issuing new tickets and a printer actuable to apply a unique identifier code to each issued ticket whereby it becomes a new redeemable ticket.

24. Apparatus according to claim 23 wherein the ticket issuing means includes a replaceable cartridge for blank tickets.

25. Apparatus according to claim 23 wherein the ticket issuing means is a discrete modular unit that is selectively and detachably mountable to said housing with a ticket issuing port on the unit in register with an opening to said branch path, whereby new tickets may be issued into said branch path for delivery to said common opening.

26. Apparatus according to claim 17 wherein said one or more pathways have one or more end openings remote from the common opening, from which end openings validated and accepted currency notes and tickets are delivered, or are able to be delivered to a storage module.

27. Apparatus according to claim 26 wherein separate said end-openings are provided for the currency notes and tickets respectively, each at an end of a respective pathway.

28. Apparatus according to claim 26 wherein said storage module is one or more discrete modular units selectively and detachably mountable to said housing.
